(19) United States
(12) Patent Application Publication
(10) Pub. No.: US 2003/0079595 A1
(43) Pub. Date: May 1, 2003

(54) Feed grip for a food slicer

(76) Inventors: Shahram Shariff, Dayton, OH (US); Doug McGuffin-Noll, Springboro, OH (US); Jeff Frock, Troy, OH (US)

Correspondence Address: MARK P. LEVY, ESQ,, THOMPSON HINE LLP, 2000 COURTHOUSE PLAZA NE, 10 WEST SECOUND STREET, DAYTON, OH, 45402-1758, US

(21) Appl. No.: 10/039,313

(22) Filed: Oct. 27, 2001

(51) Int. Cl. B26D 7/06

(52) U.S. Cl. 83/713; 83/932; 83/730; 83/409; 83/422

(57) ABSTRACT

A feed grip for being coupled to a slide rod of a slicer including a gripping plate having a front surface and rear surface, the front surface being shaped to grip a food product, the gripping plate including an attachment portion extending generally outwardly from the rear surface. The feed grip further includes a handle having an opening shaped to releasably receive the attachment portion therein, and a feed arm including a pair of annulus, a first one of the annulus being shaped to be generally located between the handle and the gripping plate, a second one of the annulus being shaped to receive the slide rod of the slicer therethrough.

The present invention is directed to a feed grip for a food slicer, and more particularly, to a feed grip that is mountable on and slidable along a slide rod of a slicer.

Commercial food product slicers are widely utilized as a rapid and effective means for slicing meat, cheese, vegetables and other food products. The slicers typically include a rotatable disk-like blade and a reciprocating carriage that brings the food product into contact with the rotating blade to cut slices from the food product. The carriage typically includes a tray for supporting the food product, and a feed grip which urges the food product into contact with a gauge plate and blade of the slicer.

### SUMMARY OF THE INVENTION

The present invention is a feed grip for use with a slicer and for urging the food product into contact with the gauge plate and blade of a slicer. In one embodiment, the feed grip has a relatively low part count, is relatively easy to assemble and clean, and has teeth that grip the food product supported on the carriage. The feed grip may also have a weight distribution that enables the feed grip to slide smoothly along a slide rod of the slicer. In another embodiment, the feed grip includes relatively long blunt teeth that effectively grip the food product.

In one embodiment the invention is a feed grip for being coupled to a slide rod of a slicer including a gripping plate having a front surface and rear surface, the front surface being shaped to grip a food product, the gripping plate including an attachment portion extending generally outwardly from the rear surface. The feed grip further includes a handle having an opening shaped to releasably receive the attachment portion therein, and a feed arm including a pair of annulus, a first one of the annulus being shaped to be generally located between the handle and the gripping plate, a second one of the annulus being shaped to receive the slide rod of the slicer therethrough. Other objects and advantages of the present invention will be apparent from the following description and the accompanying drawings.

### BRIEF DESCRIPTION OF THE DRAWINGS

FIG. 1 is a rear view of one embodiment of a slicer of the present invention;

FIG. 2 is an end view of the slicer of FIG. 1;

FIG. 3 is a top view of the carriage of the slicer of FIG. 1;

FIG. 4 is a top view of the feed grip of the carriage of FIG. 3;

FIG. 5 is a perspective exploded view of the feed grip of FIG. 4;

FIG. 6 is a side cross section of the handle of the feed grip of FIG. 4;

FIG. 7 is a side cross section of the gripping plate of the feed grip of FIG. 4;

FIG. 8 is a side cross section of the feed grip of FIG. 4; and

FIG. 9 is a detail side view of a tooth of the feed grip of FIG. 4.

### DETAILED DESCRIPTION

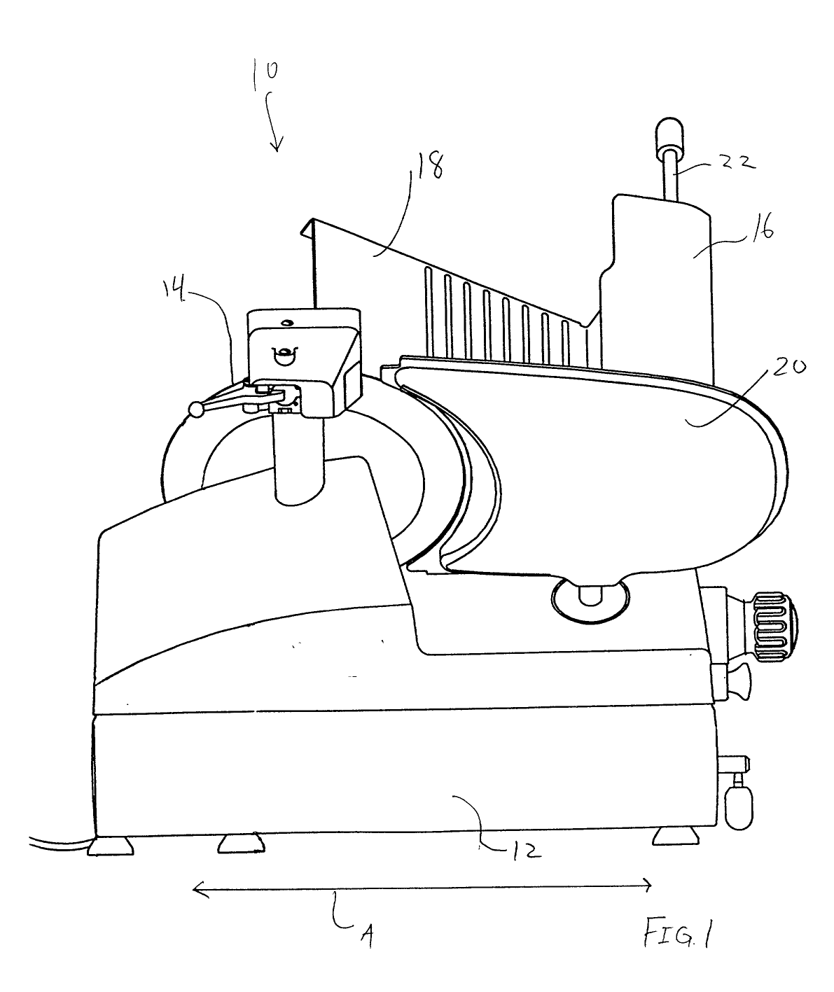

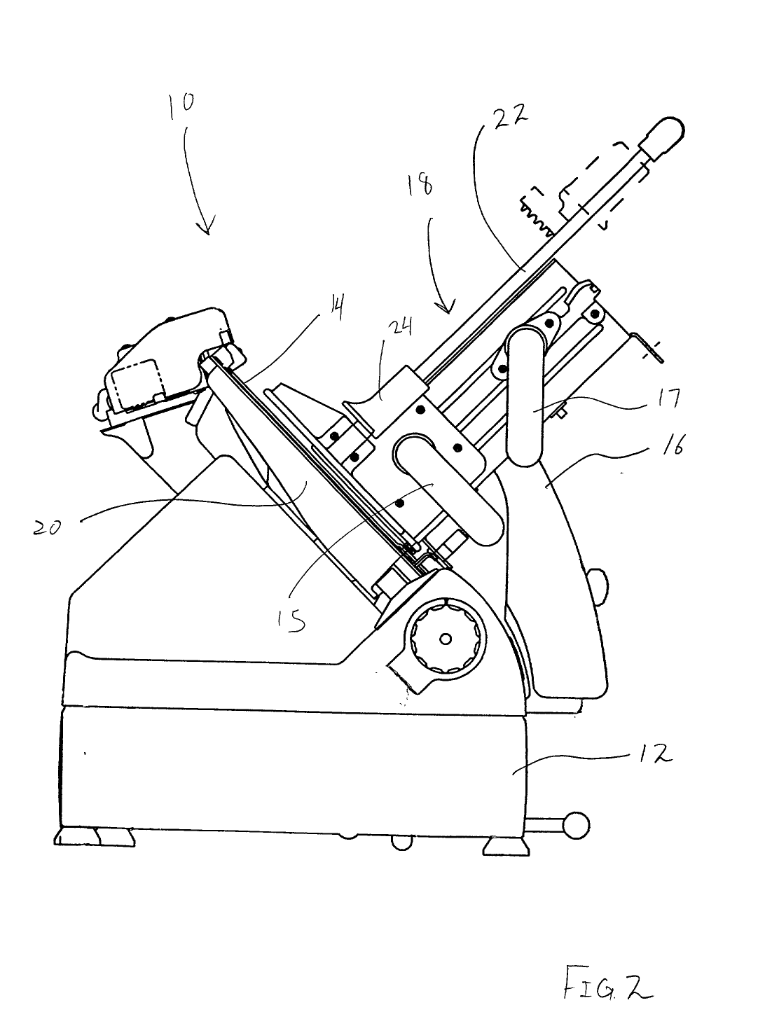

The feed grip of the present invention may be used with a slicer, generally designated 10 and shown in FIGS. 1 and 2. The slicer 10 may include a slicer body or base 12 and a disc-like blade 14 rotationally coupled to the base 12. The slicer 10 may include a carriage 16 that is mounted to the base 12 for reciprocal movement along a slicing path, indicated by arrow A of FIG. 1. The carriage 16 may include a tray or support surface 18 that is shaped to receive and support the food product (not shown) to be sliced thereon. The carriage 16 includes a pair of carriage handles 15, 17 (FIG. 2) that may be gripped to manually move the carriage 16. The slicer 10 may also include a carriage drive (not shown) for driving the carriage 16 along the slicing path A.

The base 12 includes a gauge plate 20 which can be adjusted to vary the thickness of the slices cut from the food product. The food product is preferably pressed against the gauge plate 20 during each cutting pass of the carriage 16, and the gauge plate 20 is movable closer to or further away from the plane of the blade 14 to vary the thickness of the slices.

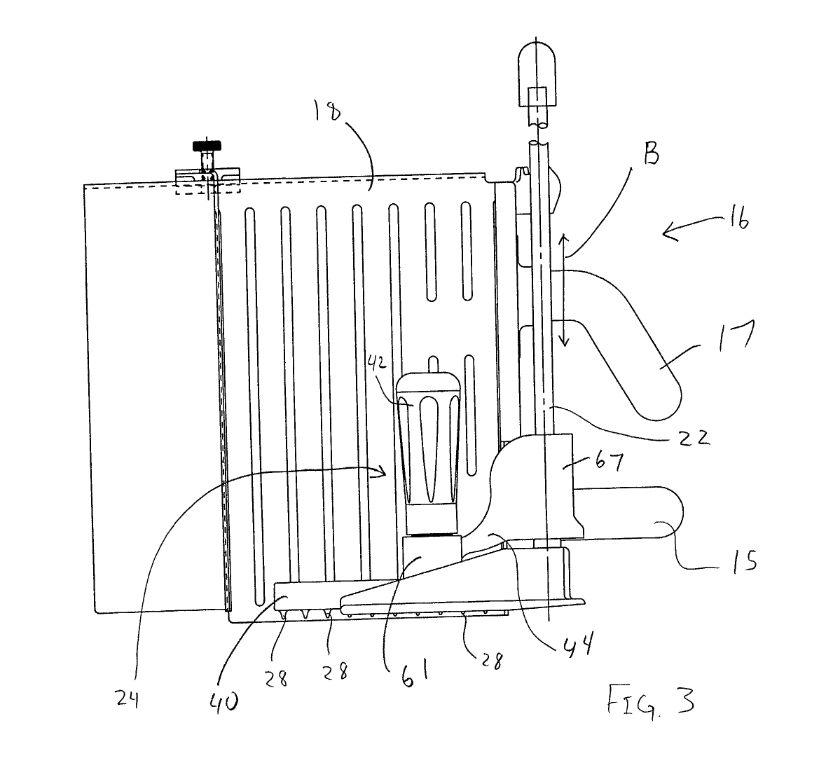

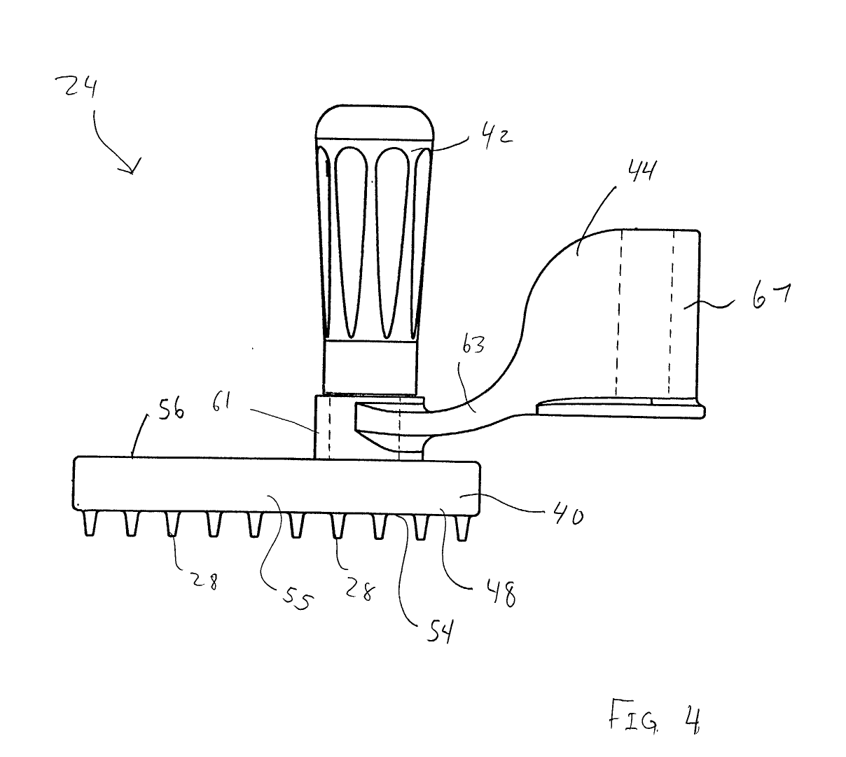

As shown in FIG. 3, the carriage 16 may include a slide rod 22 with a feed grip 24 slidably located thereon. The feed grip 24 is slidable along the slide rod 22 in the direction of arrow B (i.e., generally perpendicular to the reciprocating motion of the carriage 16 in direction A). The feed grip 24 grips the food product located on the tray 18 and urges the food product towards the blade 14 and gauge plate 20 to ensure that the food product contacts the blade 14 and gauge plate 20 during each cutting pass of the carriage 16.

The food product to be sliced can be received between the feed grip 24 and the gauge plate 20, and the user can grip the feed grip 24 and push the feed grip 24 along the slide rod 22 to urge the food product against the gauge plate 20 and blade 14. Alternately, the weight of the feed grip 24 may be sufficient that the feed grip 24 engages the food product and urges the food product into contact with the gauge plate 20 and blade 14 by the force of gravity. The feed grip 24 includes a plurality of generally forwardly extending teeth 28 for gripping the food product to hold the food product in place against the gauge plate 20 and blade 14 and prevent rotation of the food product.

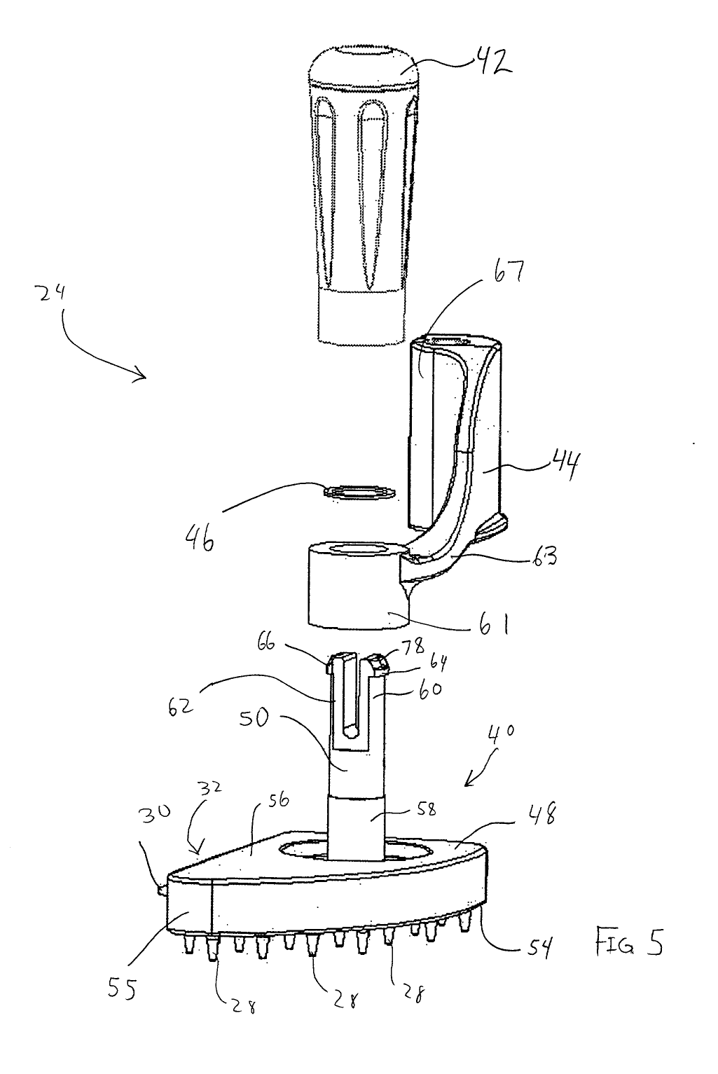

The feed grip 24 may also include a plurality of lower teeth 30 (one of which is shown in FIG. 5) that extend from a lower surface 32, and the lower teeth 30 may be used in an alternate configuration of the feed grip 24. For example, when the food product is as long as, or longer than, the tray 18, the feed grip 24 can be rotated about the slide rod 22 to rotate the feed grip 24 away from the tray 18. The food product can then be located on the tray 18, and the feed grip 24 can be rotated back around the slide rod 22 until the lower teeth 30 engage the food product in the same manner as a conventional feed grip.

As shown in FIG. 5, the feed grip 24 includes a gripping plate 40 having the teeth 28, 30 located thereon, a handle 42, a feed arm 44 located between the handle 42 and the gripping plate 40, and a wave washer 46 located between the feed arm 44 and the handle 42. The gripping plate 40 includes a plate portion or plate member 48 and an attachment portion 50 coupled to the plate portion 48. The plate portion 48 is a generally plate-like component and the plurality of teeth 28 extend generally forwardly from a front surface 54 of the plate portion. The plate portion 48 may also include the plurality of lower teeth 30 that extend from a lower surface 32 of the plate portion 48.

The attachment portion 50 is coupled to and extends generally outwardly from a rear surface 56 of the plate portion 48. The attachment portion 50 includes a generally cylindrical stub portion 58 coupled to the plate portion 48, and a pair of spaced legs 60, 62 extending from the stub portion 58. Each leg 60, 62 includes a generally outwardly-extending tip or foot 64, 66, with each tip 64, 66 having a generally rounded outer surface. The gripping plate 40 can be made from a variety of materials but is preferably made of aluminum having an overmold which couples the plate portion 48 and attachment portion 50 together. The overmold may be a variety of materials, such as nylon with about 15% glass by weight. Alternately, the gripping plate 40 may be molded as a single piece.

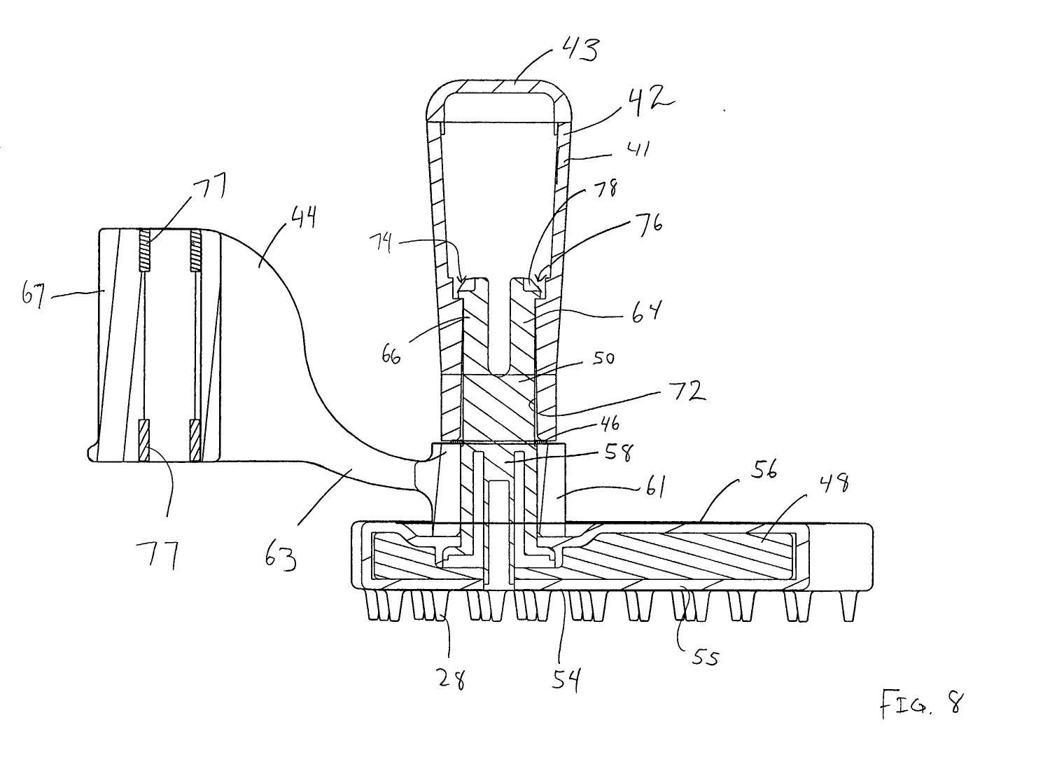

As shown in FIG. 7, the attachment portion 50 includes flared end 51, and the plate portion 48 includes a recess 53 that is shaped to receive the flared end 51 therein. Thus, in order to assemble the gripping plate 40, the flared end 51 of the attachment portion 50 is located in the recess 53. A pin (not shown) may be passed through aligned openings 57, 59 of the gripping plate 40 and attachment portion 50, and a overmold 55 may be formed over the plate portion 48 and at least the lower end of the attachment portion 50. The overmold 55 secures the attachment portion 50 in the recess 53 and prevents the attachment portion 50 from rotating relative to the gripping plate 40. A plug (not shown) may then be inserted into the opening 59.

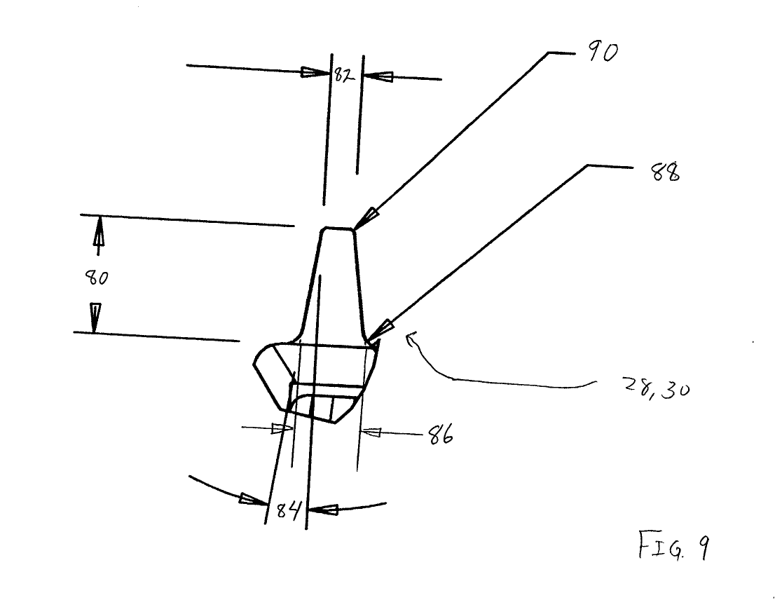

The feed arm 44 includes an annular or generally cylindrically-shaped coupling portion 61 that is shaped to receive the attachment portion 50 of the gripping plate 40 therethrough. The feed arm 44 further includes an annular or generally cylindrically-shaped slide rod portion 67 that is shaped to receive the slide rod 22 therethrough. The slide rod portion 67 may include a pair of bushings or bearings 77 located therein (FIG. 8) to reduce the friction between the feed arm 44 and the slide rod 22 to enable the feed arm 44 to slide smoothly along the slide rod 22. As will be discussed in greater detail below, the feed arm 44, and more particularly the slide rod portion 67, is preferably made of a material that contributes significantly to the overall weight of the feed grip 24. The feed arm 44 also includes a connecting portion 63 coupled to and extending between the coupling portion 61 and slide rod portion 67. The feed arm 44 can be made from a variety of materials, preferably stainless steel.

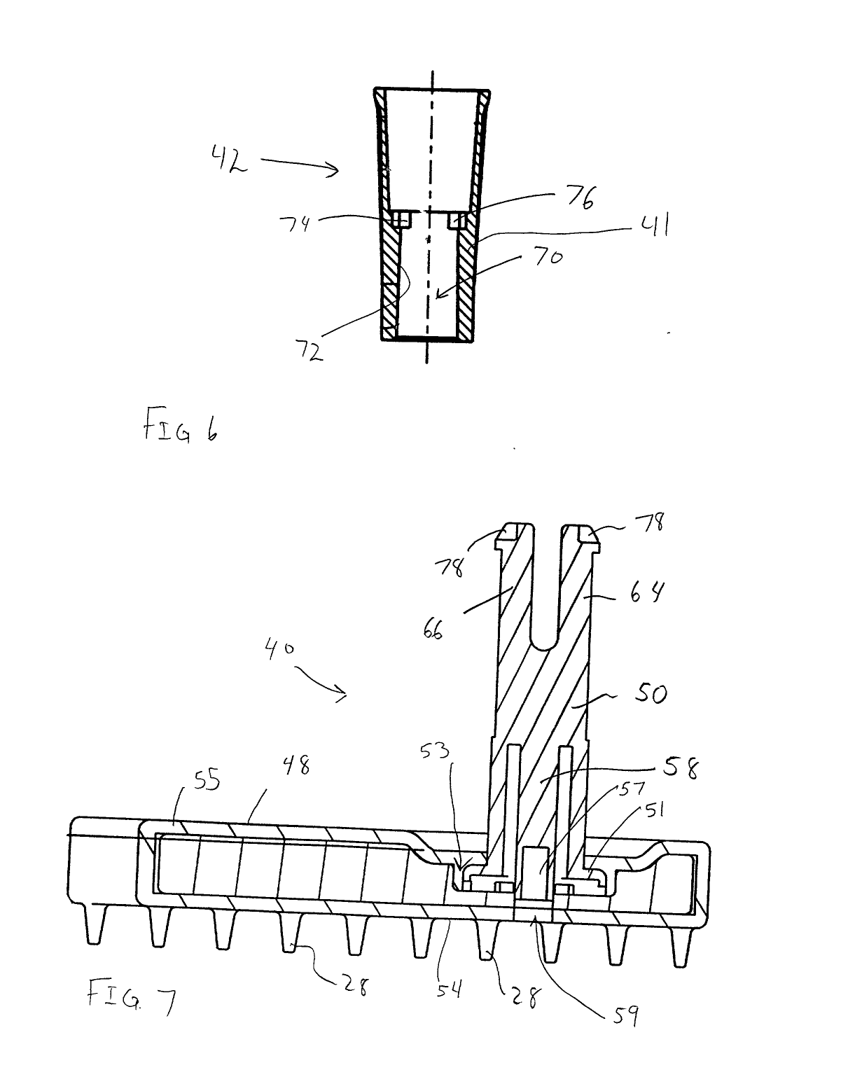

As shown in FIG. 6, the handle 42 is generally annular and includes a central cavity 70 therein. The central cavity 70 is shaped to releasably receive the legs 60, 62 of the gripping plate 40 therein. In particular, the central opening 70 includes an inwardly-tapered inner wall 72 and a pair of opposed end openings 74, 76. The end openings 74, 76 are preferably located at only a single rotational position in the handle 42; in other words, the end openings 74, 76 do not extend around the perimeter of the handle 42. As shown in FIG. 8, the handle 42 may have a two-piece construction including a body portion 41 and a cap portion 43. The handle 42 can be made from any of a variety of materials, such as polypropylene.

In order to assemble the feed grip 24, the gripping plate 40, feed arm 44, washer 46 and handle 42 are arranged in their orientation shown in FIG. 5. The attachment portion 50 of the feed arm 40 is then passed through the coupling portion 61 of the feed arm 44 and the washer 46, and received in the opening 70 of the handle 42. The inner diameters of the slide portion 61 and washer 46 may be smaller than the distance between the legs 64, 66, but the curved tips 64, 66 of the legs 60, 62 enable the legs 60, 62 to be pressed together in order to pass the legs 60, 62 through the washer 46 and feed arm 44.

When the legs 60, 62 of the gripping plate 40 engage the tapered inner wall 72 of the handle 42, the legs 60, 62 are urged toward each other. When the attachment portion 50 of the gripping plate 40 is inserted into a sufficient depth in the opening 70 of the handle 42 and the tips 64, 66 are aligned with an associated end opening 74, 76, each tip 64, 66 is received in one of the end openings 74, 76 of the handle 42 (see FIG. 8). If the tips 64, 66 are not aligned with the end openings 74, 76, it may be required to rotate the handle 42 to seat the tips 64, 66 in the end openings 74, 76. As the handle 42 is rotated, the legs 60, 62 spring apart and create a “snap” feel when the tips 64, 66 are received in the end openings.

When the feed grip 24 is assembled, the wave washer 46 is preferably at least partially compressed, and therefore urges the handle 42 and feed arm 44 apart from each other. In this manner the washer 46 helps to take up any tolerances in the system, and ensures that the tips 64, 66 remain securely retained in the end openings 74, 76. Alternately, the washer 46 may be located between the gripping plate 40 and the feed arm 44. Thus, when the feed grip 24 is assembled, the gripping plate 40 is rotationally and axially coupled to the handle 42 and feed arm 44.

In order to disassemble the feed grip 24, the tips 64, 66 can be dislodged from the end openings 74, 76 by twisting the handle 42, while holding the gripping plate 40 stationary. The curved tips 64, 66 of the legs 60, 62 enable the legs 60, 62 to be dislodged from the end openings 74, 76 when the handle 42 is rotated relative to the gripping plate 40. The attachment portion 50 is then retracted out of the central cavity 70 of the handle 42. If it is desired to completely disassemble the feed grip 24, the legs 60, 62 can be pressed together, such as by a set of pliers, such that the legs 60, 62 can be pulled through the wave washer 46 and feed arm 44. Each tip 64, 66 may include an indentation 78 (see FIGS. 5 and 7) that can receive a plier of a pair of needle nose pliers therein so that the pliers can urge the legs 60, 62 together in order to fully disassemble the feed grip 24.

The feed grip 24 of the present invention includes relatively few parts, and can be assembled and disassembled easily and without the need for tools (beyond perhaps a pair of pliers for complete disassembly). Furthermore, as noted above, the slide rod portion 67 of the feed arm 44 preferably contributes a significant portion of the weight of the feed arm 44 and of the feed grip 24. The slide rod portion 67 may contribute about 50-90% of the weight of the feed arm 44, preferably about 75%. The slide rod portion 67 may contribute about 40-60% of the weight of feed grip 24, preferably about 50%.

By having the slide rod portion 67 contribute a significant portion of the weight of the feed arm 44 and feed grip 24, the center of gravity of the feed grip 24 is shifted closer to the slide rod portion 67 and to the slide rod 22, and the moment arm of the feed grip 24 upon the slide rod 22 is reduced. By shifting the center of gravity close to the slide rod 22, the frictional engagement between the feed grip 24 and the slide rod 22 is reduced. For example, the center of gravity of the feed grip 24 may be less than about 3 inches from the center of the slide rod 22, preferably about 2 inches or less. The center of gravity of the feed arm 44 may be less than about 2 inches from the center of the slide rod 22, preferably about 1 inch or less.

By concentrating the weight of the feed grip 24 and feed arm 44 about the slide rod portion 67 and locating the centers of gravity of the feed grip 24 and feed arm 44 closer to the slide rod 22, the moment arm of the feed grip 24 is reduced, the binding of the feed grip 24 upon the slide rod 22 is reduced. In this manner the feed grip 24 can thereby slide smoothly up and down the slide rod 22 without binding upon the slide rod 22. The friction between the feed grip 24 of the present invention and the slide rod 22 may be reduced sufficiently that the gravity can pull the feed grip 24 down along the slide rod 22 and urge the food product into contact with the gauge plate 20 and blade 14 by the weight of the feed grip 24. Thus, the slide rod portion 67 is preferably made of a relatively heavy material, such as stainless steel, which has a density of about 0.29 lb/in³. Alternately, of course, the remaining portions of the feed grip 24, such as the handle 42, coupling portion 61, connecting portion 63 and gripping plate 40 can be made of relatively light materials compared to the slide rod portion 67. The slide rod portion 67 can also be made relatively long or thick to move the center of gravity closer to the slide rod 22.

The teeth 28, 30 of the feed grip 24 may be relatively long and blunt. For example, as shown in FIG. 9, each tooth 28, 30 may have a length 80 of about 0.35 to about 0.40 inches long, preferably about 0.375 inches. Each tooth 28, 30 may have a tip diameter 82 of about 0.050 inches to about 0.15 inches, preferably about 0.10 inches. Each tooth 28, 30 may have a taper angle 84 of about 6° to about 10°, preferably about 8°. Each tooth 28, 30 may have a base diameter 86 of between about 0.15 to about 0.25 inches, preferably about 0.20 inches. Each tooth 28, 30 may include a lower radius 88 that serves as a transition from the tooth 28, 30 to the plate portion 48, and the lower radius 88 is preferably about 0.60 inches. Each tooth 28, 30 may also include an upper radius 90 that serves as the transition from the side of the tooth to the tip of the tooth, and the upper radius 90 is preferably about 0.20 inches.

These dimensions for the teeth 28, 30 provide relatively long, blunt teeth. The blunt nature of the teeth helps to reduce cutting or tearing of the food products that are engaged by the plate portion 48. In other words, the blunt teeth may simply cause indentations in the food products, which improves the integrity of the food product as compared to teeth that pierce and penetrate the food product. Furthermore, because the blunt teeth 28, 30 have a relatively large surface area on their tips, the tips of the teeth can frictionally engage the food product to retain the food product in place. The increased length of the teeth 28, 30 also improves the durability of the teeth. Finally, because the teeth 28, 30 are relatively blunt, the base of the teeth can be relatively thick which enables the teeth to be firmly coupled to the gripping portion 48. The teeth 28, 30 can be made from a variety of materials, preferably aluminum with an outer coating of nylon such as the same nylon coating located on other surfaces of the entire gripping plate 40.

Having described the invention in detail and by reference to the preferred embodiments, it will be apparent the modifications and variations thereof are possible without departing from the scope of the invention.

What is claimed is:

1. A feed grip for being coupled to a slide rod of a slicer comprising:
a gripping plate having a front surface and rear surface, said front surface being shaped to grip a food product, said gripping plate including an attachment portion extending generally outwardly from said rear surface, said attachment portion including a pair of opposed, generally laterally extending feet;
a handle having an opening shaped to releasably receive said attachment portion therein; and
a feed arm including a pair of annulus, a first one of said annulus being shaped to be generally located between said handle and said gripping plate, a second one of said annulus being shaped to receive said slide rod of said slicer therethrough.

2. The feed grip of claim 1 further comprising a wave washer located between said handle and said feed arm or between said feed arm and said gripping plate such that when said wave washer is compressed said wave washer urges the adjacent components away from each other.

3. The feed grip of claim 1 wherein said gripping plate includes a plurality of teeth extending generally forwardly from said front side.

4. The feed grip of claim 3 wherein each of said teeth has a length of between about 0.35 and about 0.40 inches and has a tip diameter of between about 0.05 inches to about 0.15 inches.

5. The feed grip of claim 1 wherein said first one of said annulus is shaped to receive said attachment portion of said gripping plate therethrough.

6. The feed grip of claim 5 wherein said feed arm includes a connecting arm coupled to and extending between both of said annulus.

7. The feed grip of claim 1 wherein said attachment portion includes a pair of spaced generally parallel legs, each leg being coupled to one of said feet, and wherein said opening of said handle includes a pair of opposed end openings, each end opening being shaped to receive one of said feet therein to couple said feed grip to said handle.

8. The feed grip of claim 7 wherein each foot extends generally outwardly from the associated leg and includes a curved outer surface.

9. The feed grip of claim 1 wherein said opening of said handle includes a generally inwardly tapered side wall such that said feet engage said side wall and are urged together when said attachment portion is urged into said opening.

10. The feed grip of claim 10 wherein said second one of said annulus contributes at least 50% of the weight of said feed grip.

11. A slicer comprising:
a) a slicer body having a rotatable blade mounted thereon and a motor for rotatably driving said blade; and
b) a carriage including a support surface for supporting a product to be sliced, said carriage being mounted for reciprocal movement relative to said body to bring a product to be sliced into and out of contact with said blade, said carriage including a slide rod located adjacent to said support surface and a feed grip that is slidable along said support surface in a direction generally perpendicular to the reciprocal movement of said carriage, said feed grip including:
i) a gripping plate having a front surface and rear surface, said front surface being shaped to grip a food product, said gripping plate including an attachment portion extending generally outwardly from said rear surface, said attachment portion including a pair of opposed, generally laterally extending feet;
ii) a handle having an opening releasably receiving said attachment portion therein; and
iii) a feed arm located generally between said handle and said gripping plate, said feed arm including a slide rod portion receiving said slide rod of said slicer therethrough.

12. A feed grip installable on a slide rod of a slicer comprising:
a gripping plate assembly formed by a plate member having a recess, an attachment portion positioned in and extending from said recess, and an overmold layer covering said plate member and at least a portion of said attachment portion to secure said attachment portion in said recess and prevent said attachment portion from rotating relative to said plate member.

13. The feed grip of claim 12 further including a handle having an opening and wherein said attachment portion includes at least two spaced, flexible legs for removably coupling said attachment portion to said handle.

14. The feed grip of claim 13 wherein each leg includes a generally outwardly extending foot located at an end thereof, and wherein said handle includes a pair of opposed end openings, each end opening being shaped and located to receive one of said feet therein to removably couple said attachment portion to said handle.

15. The feed grip of claim 14 wherein said opening of said handle includes a generally inwardly tapered side wall such that said feet engage said side wall and are urged together when said attachment portion is urged into said opening.
